(19) United States
(12) Patent Application Publication
(10) Pub. No.: US 2023/0312385 A1
(43) Pub. Date: Oct. 5, 2023

(54) METHOD AND SYSTEM FOR PROCESSING OF BIOLOGICAL WASTE

(71) Applicant: SCANSHIP HOLDING ASA, Lysaker (NO)

(72) Inventors: Pal Jahre NILSEN, Lysaker (NO); Oda Kjorlaug SVENNEVIK, Lysaker (NO)

(21) Appl. No.: 18/023,234

(22) PCT Filed: Aug. 27, 2021
(86) PCT No.: PCT/EP2021/073704

§ 371 Date: Feb. 24, 2023

(30) Foreign Application Priority Data
Aug. 28, 2020 (EP) 20193386.8

(51) Int. Cl. C02F 9/00; B09B 3/45; B09B 3/65; C01B 3/02; C10G 1/00; F23G 5/00

(52) U.S. Cl. CPC C02F 9/00; B09B 3/45; B09B 3/65; C01B 3/02; C10G 1/002; F23G 5/006; C02F 11/18

(57) ABSTRACT

The present invention provides a method and a system for processing of waste by anaerobic digestion, said method comprising pre-treatment of a first biological waste stream by thermal hydrolysis and processing of a solid fraction by pyrolysis prior to anaerobic digestion.

The present invention allows for efficient utilization of the energy available in biological waste sources. The method provides an energy efficient method for processing of biological waste having a high degree of recovery of the energy stored in the waste material, wherein the flow of material may be dynamically adjusted to e.g. achieve end products in preferred ratios.

### FIELD OF THE INVENTION

The present invention relates to processing of waste and the possible utilization of the waste material in processes for the production of energy, e.g. by subjecting at least part of the processed waste to anaerobic digestion, as well as the possible use of nutrients and other elements isolated from or based on the processed waste stream.

### BACKGROUND OF THE INVENTION

The human demand on natural resources is a growing challenge demanding both the recycling of basic nutrients and the use of renewable energy. These growing demands have greatly impacted on waste disposal processes gradually changing the focus from a mere disposal towards a recycling process.

One example is the processing of biological waste by anaerobic digestion from which products, such as biofuel may be extracted.

Pre-treatment of such biological material is often applied to increase the degree of completeness to which the biological material is processed during anaerobic digestion.

Such pre-treatment may be mechanical fragmentation of the biological material, such as by ultrasonic pulse treatment, high pressure homogenization or grinding, biological pre-treatment, such as enzymatic treatment or chemical pre-treatment either by thermal hydrolysis or chemical hydrolysis, such as acid or alkaline hydrolysis.

Another known method for processing of biological waste is to subject the waste to pyrolysis resulting in an efficient reduction of waste volume and end products, such as syngas, pyro-oil and Biochar, which may be utilized for various purposes, such as for fuel in e.g. boiler systems, diesel engines or as a substitute for petroleum and carbon sequestration, respectively. Recently, syngas and pyro-oil have been added to a digester to increase biological methane production from anaerobic digestion of biological waste.

One example is disclosed in WO 2013/110186, which relates to wastewater treatment wherein an anaerobic digester is fed to a feedstock, for example sludge from a municipal wastewater treatment plant, and produces a digestate. The digestate is dewatered into a cake. The cake may be dried further, for example in a thermal drier. The cake is treated in a pyrolysis system to produce a synthesis gas and biochar. The gas is sent to the same or another digester to increase its methane production. The char may be used as a soil enhancer.

Another example is disclosed in WO 2017/156629, which relates to treating waste such as municipal solid waste, wherein waste, such as municipal solid waste (MSF), is separated into a wet fraction and refuse derived fuel (RDF). For example, the waste may be separated in a press. The wet fraction is treated in an anaerobic digester. The RDF is further separated into a cellulosic fraction and a non-cellulosic fraction. The cellulosic fraction is treated by pyrolysis and produces a pyrolysis liquid. The pyrolysis liquid is added to the anaerobic digester.

Yet another example is disclosed in WO 2017/161445, which relates to pyrolysis performed in two stages. The first stage treats a feedstock comprising organic waste to produce permanent gas, liquid (which may be condensed from vapor), and char. The second stage treats the char produced in the first stage. At least some of the first stage char (which may include oil in the pores of the first stage char) is converted into a gas in the second stage. The temperature of the first stage is preferably 450 degrees C. or less. The temperature of the second stage is higher than the temperature of the first stage, for example by 50 degrees C. or more.

Pyrolysis is mainly used for processing of solid biological waste. Most biological waste sources are dewatered and/or dried prior to pyrolysis to reduce the energy requirement of the pyrolysis process. Any residual liquid from such a dewatering treatment must be disposed of or further processed.

To solve this challenge, any residual liquid from such a dewatering process has often been cleaned using conventional scrubbers. More recently, pyrolysis has been paired with anaerobic digestion of extracted liquid parts of a biological waste stream in order to recover renewable energy for use in the pyrolysis reactor, whereby the overall requirement for supply of external energy for the pyrolysis is reduced.

One example of such a pairing is disclosed in CN108423959, which discloses a resource utilization method of sludge based on thermal hydrolysis-pyrolysis carbonization. The method includes the steps of: transporting dehydrated sludge to a sludge preheater; sending the preheated sludge into a sludge thermal hydrolysis reaction kettle; subjecting the thermal hydrolysis product to solid-liquid separation to obtain thermal hydrolysis filtrate and a solid product; carrying out natural heap drying, crushing, activation and granulation on the solid product successively, then conveying the product to a rotary controllable pyrolysis carbonization furnace by a spiral conveyer, and conducting high-temperature rapid pyrolysis to obtain biochar, tar and high-temperature waste gas, introducing the high temperature waste gas into the sludge preheater, and subjecting the biochar to resource comprehensive utilization; and subjecting the thermal hydrolysis filtrate to anaerobic fermentation, and using the generated biogas as the fuel of the pyrolysis carbonization furnace.

Another method is disclosed in WO2017/197508, which describes a system and process for treating anaerobic digester sludge (digestate) to produce biochar in which the digestate is dosed with metal cations, dewatered, optionally dried, and pyrolyzed. The added metal ions form precipitates of e.g. struvite, hydroxyapatite, brushite, or other compounds in the digestate, which remain in the biochar, and e.g. increases the phosphorous content of the biochar.

The combination of pyrolysis and anaerobic digestion in waste processing has increased the recovery of the renewable energy in the waste material by biological methane production in the anaerobic digestion. The processing of syngas in the bioreactor has furthermore reduced the need for chemical treatment of syngas to yield methane and reduced the cost as well as environmental hazard of methane production from waste sources.

Despite recent development, challenges still remain. Given the nature of waste material, there is in many known processes an inherent risk of disturbance of the microbiology in the reactor for anaerobic digestion, which leads to demands for surveillance and regular intervention to maintain an efficient anaerobic digestion. Furthermore, the digestate resulting from many known processes will, if this is not processed by e.g. pyrolysis, but disposed of or further utilized, have to be sterilized to eliminate health risks associated with such a contamination.

Current waste disposal and recycling processes are all costly to perform and the utilization of the recycled material for e.g. energy production only partially compensates for the high costs.

Basic nutrients, such as nitrogen and phosphorous species are only purely recovered in the known processes.

There is, thus, still a need for waste managing systems having a more efficient and complete utilization of energy and valuable nutrients from biological waste materials.

### SUMMARY OF THE INVENTION

In a first aspect, the present invention relates to a method for processing of waste comprising the steps of
a) conveying a first biological waste stream into a reactor for thermal hydrolysis to achieve a content of said reactor for thermal hydrolysis, having a dry solid content in the range of 15-35%, and subjecting said content to thermal hydrolysis producing a hydrolysate
b) conveying said hydrolysate to a decanter and separating said hydrolysate into at least a first fraction (1) and a second fraction (2), wherein said first fraction (1) is characterized by having a lower dry solid content relative to said hydrolysate and wherein said second fraction (2) is characterized by having a higher dry solid content relative to said hydrolysate and wherein the dry solid content of said second fraction (2) is in the range of 30%-50%
c) conveying at least part of said second fraction (2) to a dryer and separating said second fraction (2) into a third fraction (3) having a lower dry solid content than said second fraction (2) and a fourth fraction (4) having a higher dry solid content relative to said second fraction (2) and wherein said dry solid content of said fourth fraction (4) is in the range of 50-95%
d) conveying at least part of said fourth fraction (4) to a reactor for pyrolysis subjecting said at least part of said fourth fraction (4) to a pyrolysis process resulting in the production of Biochar and a fifth fraction (5) comprising syngas and/or pyro-oil
e) conveying at least part of said first fraction (1) and at least part of said fifth fraction (5) to a bioreactor for anaerobic digestion and subjecting said at least part of said first fraction (1) and said at least part of said fifth fraction (5) to anaerobic digestion,
wherein the proportion of said first fraction (1) conveyed to said bioreactor may be adjusted and,
wherein both the content of syngas and the content of pyro-oil in said at least part of said fifth fraction (5) conveyed to said bioreactor may be adjusted.

In a second aspect, the present invention relates to a system for processing of biological waste comprising
a) a reactor for thermal hydrolysis
b) a decanter
c) a dryer
d) a reactor for pyrolysis
e) a bioreactor for anaerobic digestion
said reactor for thermal hydrolysis being fluently connected to said decanter, and
said decanter being fluently connected to said bioreactor for anaerobic digestion and to said dryer, wherein said decanter is configured to convey a first fraction (1) to said bioreactor for anaerobic digestion having a lower dry solid content relative to the input material received from said reactor for thermal hydrolysis and said decanter being further configured to convey a second fraction (2) to said dryer having a higher dry solid content relative to the input material received from said reactor for thermal hydrolysis and wherein said dry solid content of said second fraction (2) is in the range of 30%-50%, and
said dryer further being fluently connected to said reactor for pyrolysis and wherein said dryer is further fluently connected to said bioreactor and/or fluently connected to said reactor for thermal hydrolysis and wherein said dryer is configured to convey a fourth fraction (4) to said reactor for pyrolysis having a higher dry solid content relative to said second fraction (2) and wherein said dry solid content of said fourth fraction (4) is in the range of 50%-95% and wherein said dryer is further configured to obtain a third fraction (3) having a lower dry solid content relative to said second fraction (2) said reactor for pyrolysis further being fluently connected to said bioreactor.

### BRIEF DESCRIPTION OF THE FIGURES

FIG. 1 is a schematic drawing of a waste processing method according to the present invention.

FIG. 2 is a schematic drawing of a waste processing method according to the present invention, further comprising a heat exchanger and wherein said third fraction (3) is conveyed to said reactor for thermal hydrolysis (TH) and thereby pre-heats said content in said reactor for thermal hydrolysis (TH).

FIG. 3 is a schematic drawing of a waste processing method according to the present invention, wherein part of the biochar is conveyed to the bioreactor to assist in the anaerobic digestion and increase the quality of the pathogen free reject with nutrients as a fertilizer.

FIG. 4 is a schematic drawing of a waste processing method according to the present invention wherein, said first fraction (1) and said third fraction (3) are passed through a heat exchanger. Said heat exchanged is used to pre-heat water for production of steam (7) for use in thermal hydrolysis.

FIG. 5 is a schematic drawing of a preferred drying method (SSD) according to the present invention.

### DETAILED DESCRIPTION OF THE INVENTION

The present invention relates to a method for processing of biological material comprising the steps of:
a) Conveying a first biological waste stream into a reactor for thermal hydrolysis, to achieve a content of said reactor for thermal hydrolysis, having a dry solid content in the range of 15-35%, and subjecting said content to thermal hydrolysis producing a hydrolysate
b) conveying said hydrolysate to a decanter and separating said hydrolysate into at least a first fraction (1) and a second fraction (2), wherein said first fraction (1) is characterized by having a lower dry solid content relative to said hydrolysate and wherein said second fraction (2) is characterized by having a higher dry solid content relative to said hydrolysate and wherein the dry solid content of said second fraction (2) is in the range of 30%-50%
c) conveying at least part of said second fraction (2) to a dryer and separating said second fraction (2) into a third fraction (3) having a lower dry solid content than said second fraction (2) and a fourth fraction (4) having a higher dry solid content relative to said second fraction (2) and wherein said dry solid content of said fourth fraction (4) is in the range of 50-95%
d) conveying at least part of said fourth fraction (4) to a reactor for pyrolysis subjecting said at least part of said fourth fraction (4) to a pyrolysis process resulting in the production of Biochar and a fifth fraction (5) comprising syngas and/or pyro-oil
e) conveying at least part of said first fraction (1) and at least part of said fifth fraction (5) to a bioreactor for anaerobic digestion and subjecting said at least part of said first fraction (1) and said at least part of said fifth fraction (5) to anaerobic digestion.
wherein the proportion of said first fraction (1) conveyed to said bioreactor may be adjusted, and
wherein both the content of syngas and the content of pyro-oil in said at least part of said fifth fraction (5) conveyed to said bioreactor may be adjusted.

In one embodiment of the invention, the method for processing of waste comprises the steps of;
a) subjecting a first biological waste stream having a dry solid content in the range of 15-35% to thermal hydrolysis producing a hydrolysate
b) subjecting said hydrolysate to decanting, whereby said hydrolysate is separated into at least a first fraction (1) and a second fraction (2), wherein said first fraction (1) is characterized by having a lower dry solid content relative to said hydrolysate and wherein said second fraction (2) is characterized by having a higher dry solid content relative to said hydrolysate and wherein the dry solid content of said second fraction (2) is in the range of 30%-50%
c) subjecting said second fraction (2) to drying in a closed system dryer, whereby said second fraction (2) is separated into at least a third fraction (3) comprising substantially all evaporating material and having a lower dry solid content than said second fraction (2) and a fourth fraction (4) having a higher dry solid content relative to said second fraction (2), and wherein said dry solid content of said fourth fraction (4) is in the range of 50-95%
d) subjecting said fourth fraction (4) to pyrolysis resulting in the production of Biochar and a fifth fraction (5) comprising syngas and/or pyro-oil
e) subjecting said first fraction (1) and at least part of said fifth fraction (5) to anaerobic digestion in a bioreactor
f) subjecting said third fraction (3) to anaerobic digestion in said bioreactor or recycle said third fraction (3) to said biological waste stream and/or said hydrolysate or subjecting at least part of said third fraction (3) to anaerobic digestion in said bioreactor and recycle the remaining part of said third fraction (3) to said biological waste stream and/or said hydrolysate
The present invention allows for efficient utilization of the energy available in biological waste sources. The method provides an energy efficient method for processing of biological waste having a high degree of recovery of the energy stored in the waste material, wherein the flow of material may be dynamically adjusted to e.g. achieve end products in preferred ratios.

The energy stored in a carbon-based material, such as a biological material present in a waste stream, can be evaluated by measuring the Chemical Oxygen Demand (COD). COD contributing compounds which are available for anaerobic digestion may be converted to products, such as methane and alcohol, during anaerobic digestion in a bioreactor. Measuring the COD of a given fraction of a waste stream, in the processing of waste, thus provides a measure of the amount of COD contributing compounds comprised in said fraction. Measuring of the COD is based on the fact that most organic compounds are fully oxidized to carbon dioxide when exposed to a strong oxidizing agent under acidic conditions. Suitable oxidizing agents are well known to the skilled person including potassium dichromate commonly used for measuring COD. Some oxidizing agents, such as potassium dichromate, does not oxidize ammonia into nitrate and the COD measurements based on such oxidizing agents will not include the oxygen demand caused by this nitrification. The COD value measured may thus depend on the specific method applied. In the context of the present invention, the COD is measured by the sealed tube method as described in ISO standard 15705:2002.

In the context of the present invention, thermal hydrolysis is used for pre-treatment. Thermal hydrolysis provides fragmentation of complex structures such as plant fibers, complex carbohydrates, such as cellulose and starch, and proteins. Complex carbohydrates are fragmented into shorter chains of carbohydrates including mono- and disaccharides, which are readily or at least more soluble in water. Such a fragmentation increases the availability of e.g. the saccharides for anaerobic digestion and thus increases the efficiency of the anaerobic digestion step, both increasing the completeness of the digestion and allowing for a reduced retention time in the bioreactor.

Thermal hydrolysis is in general a well-known process for producing a hydrolysate, involving heating of the input material to a target temperature in the range of 60° C. to 275° C. at a pressure of at least saturation pressure of the liquid part of the input material, and maintaining the target temperature and corresponding pressure for 10 to 180 minutes, followed by a sudden drop in pressure. In the context of the present invention, the preferred target temperature is at least 140° C., more preferably in the range of 140° C. to 250° C., even more preferably in the range of 160° C. to 180° C. and most preferably 170° C. In the context of the present invention, the preferred period of time used for the thermal hydrolysis is up to 2 hours, such as up to 1.5 hours, e.g. 1 hour, such as 15-30 minutes.

In a method for processing of biological material according to the present invention, a first biological waste stream is fed to a reactor for thermal hydrolysis.

In the context of the present invention, a first biological waste stream is to be construed as organic material, comprising carbon-based compounds, such as kitchen waste, wastewater from kitchen and sanitation (sewage sludge, biowaste and lignocellulosic material). Said first biological waste stream is further characterized by comprising elements readily digestible by microorganisms, such as saccharides e.g. in the form of carbohydrates and amino acids e.g. in the form of proteins. In the context of the present invention, a first biological waste stream does not need to be a waste product as such. Biological material extracted for the purpose of producing a particular product, such as biofuel e.g. methane or alcohol or for production of biochar, is also to be construed as a first biological waste stream.

The dry solid content of said first biological waste stream may be adjusted if required to achieve a content of said reactor for thermal hydrolysis, of a dry solid content in the range of 15-35%. Thus, said first biological waste stream may be either diluted or dewatered prior to conveying of said first biological waste stream to said reactor for thermal hydrolysis. Alternatively, said first biological waste stream may be diluted inside said reactor for thermal hydrolysis to achieve a content of said reactor for thermal hydrolysis, having a dry solid content in the range of 15-35%.

The dry solid content is a commonly used parameter in the context of waste processing. The dry solid content is expressed in percentage of weights of a waste material for which any water content has been removed as compared to the weight of said material before the removal of water.

Following the thermal treatment at a pressure corresponding to or higher than the saturation pressure of the liquid part of the input material, the material is subjected to a sudden drop in pressure by releasing the pressure creating a drop in pressure from saturation pressure at the target temperature to atmospheric pressure, i.e. a steam explosion. During a steam explosion, the pressure drop will cause the pressurized warm liquid to convert into steam and consequently expand and thereby cause a steam explosion, which mechanically destroys any large structures such as plant fibers and complex carbohydrates. A steam explosion may be achieved by releasing the pressurized material in the thermal hydrolysis reactor to a pressure relief tank. The resulting hydrolysate will comprise an increased amount of solubilized carbon-based compounds originating from insoluble complex compounds such as cellulose and starch. Performing the thermal hydrolysis will result in a hydrolysate having at least a much lower germ count than the incoming biological waste material, and in many situations in a sterile hydrolysate. A sterile hydrolysate or a hydrolysate having a lower germ count than the incoming biological waste material is advantageous because this will reduce the risk of downstream contamination with unwanted microorganisms and thereby make it easier to control the composition of the microorganism environment in the bioreactor. Furthermore, the bioreactor effluent will have a predictable microbiological composition allowing for increased value of the effluent for use, such as for soil fertilization.

In one embodiment, process gasses resulting from said thermal hydrolysis is conveyed to said bioreactor and subjected to anaerobic digestion. Said process gasses comprise part of the COD contributing compounds of the biological waste material and conveying of said process gasses to said bioreactor will thus contribute to a more complete utilization of the biological waste material. Furthermore, said process gasses comprise malodorous compounds, such as sulfuric compounds, and conveying of said process gasses to said bioreactor efficiently removes such malodorous compounds as those will be degraded in the bioreactor.

The hydrolysate of the first biological waste stream is conveyed to a decanter, wherein the waste stream is separated into at least a first fraction and a second fraction. Said first fraction is characterized by having a lower dry solid content relative to said hydrolysate, preferably said first fraction has a dry solid content of 10% or less, more preferably said first fraction has a dry solid content in the range of 1% to 8%, most preferably said first fraction has a dry solid content in the range of 1% to 5%. Said second fraction is characterized by having a higher dry solid content relative to said hydrolysate and further characterized by having a dry solid content in the range of 30%-50%.

Any decanter suitable for separating a waste stream into at least two fractions characterized by their relatively dry solid content may be used. Examples of such decanters are decanter centrifuges, filter-based decanters, screw presses or belt press decanters already known in the field of waste management.

At least part of said first fraction comprising solubilized carbon-based compounds including mono- and disaccharides is conveyed to a bioreactor, in which microorganisms convert the carbon-based compounds into biofuel, preferably methane by anaerobic digestion. Preferably said first fraction comprising solubilized carbon-based compounds including mono- and disaccharides is conveyed to a bioreactor in which microorganisms convert the carbon-based compounds into biofuel, preferably methane by anaerobic digestion.

In a preferred embodiment of the invention, said at least part of said first fraction is passed through a heat exchanger before reaching said bioreactor. In a most preferred embodiment of the invention, said first fraction is passed through a heat exchanger before reaching said bioreactor. In both of the above embodiments, the heat exchange lowers the temperature of said at least part of said first fraction to a temperature in the range of 20° C. to 40° C. so that the microorganisms in the bioreactor are not heat shocked, and at the same time provide means for re-using the heat. The re-usable heat may be used for any purpose. Preferably, the re-usable heat is used to assist the heating of said first biological waste stream e.g. by assisting in heating water in a boiler generating steam for use in the thermal hydrolysis. Reusing the heat reduces the requirement for external supply of energy. If the heat is reused to assist in the thermal hydrolysis, the requirement for external supply of energy is reduced for the thermal hydrolysis step.

Said second fraction comprising insoluble elements, which are not easily digested in said bioreactor, is conveyed to a dryer, for further reduction of the liquid content of the fraction, resulting in a fourth fraction having a higher dry solid content relative to said second fraction. The dry solid content of said fourth fraction is preferably in the range of 50% to 95%, more preferably in the range of 60% to 95%, most preferably in the range of 75% to 95%.

The dryer is preferably a closed system dryer comprising a closed system, in which substantially all evaporating material may be collected into a third fraction. The closed system of the dryer further provides protection from the surrounding air and thereby minimizes the risk of contamination.

In one embodiment, at least part of said third fraction is condensed in a condenser and conveyed to said bioreactor and subjected to anaerobic digestion. In a preferred embodiment, said third fraction is condensed in a condenser and conveyed to said bioreactor and subjected to anaerobic digestion. In both of the above embodiments, said condenser preferably functions as a heat exchanger allowing for re-use of any excess heat. The re-usable heat may be used for any purpose. Preferably, the re-usable heat is used to assist the heating of said first biological waste stream, e.g. by assisting in heating water in a boiler generating steam for use in thermal hydrolysis. Reusing the heat reduces the requirement for external supply of energy. If the heat is reused to assist in the thermal hydrolysis, the requirement for external supply of energy is reduced for the thermal hydrolysis step.

Said third fraction comprises volatile organic compounds, which may be metabolized in the bioreactor. Conveying at least part of said third fraction to the bioreactor will increase the part of the COD contributing compounds of the biological waste material being conveyed to the bioreactor, and thus will contribute to a more complete utilization of the biological waste material for the production of methane in the bioreactor and thereby increase the yield of methane production in the bioreactor.

In one embodiment, at least part of said third fraction is recycled and mixed with said first biological waste stream. In a preferred embodiment, said third fraction is recycled and mixed with said first biological waste stream. Recycling of at least part of said third fraction to the reactor for thermal hydrolysis reduces the need for external supply of water for dilution of said first biological waste stream when said first biological waste stream has a dry solid content above 35%. Recycling of at least part of said third fraction to the reactor for thermal hydrolysis may in addition provide pre-heating of said first biological waste stream, when said third fraction has a temperature higher than said first biological waste stream. In another embodiment, at least part of said third fraction is led through a heat exchanger. In a preferred embodiment said third fraction is led through a heat exchanger. Leading at least part of said third fraction through a heat exchanger may provide pre-heating of e.g. feed water in a boiler, generating steam for use in the thermal hydrolysis following which it may be recycled and mixed e.g. with said hydrolysate resulting in a reduction of the viscosity of said hydrolysate and thereby an easier, i.e. less energy demanding, subsequent decanting process. In all of these embodiments, pre-heating said first biological waste stream reduces the need for external supply of energy for generating heat and thus increases the energy efficiency of the overall method. Furthermore, recycling of at least part of said third fraction to the reactor for thermal hydrolysis, instead of diluting said first biological waste stream with water, increases the concentration of COD contributing compounds in the liquid part of the resulting hydrolysate and thereby reduces the overall volume of liquid needed to convey said COD contributing compounds to the bioreactor for anaerobic digestion and production of methane.

In one embodiment, for which said first biological waste stream has a dry solid content of 35% or less, at least part of said third fraction is passed through a heat exchanger following which it may be recycled and mixed e.g. with said hydrolysate or conveyed to the bioreactor. In a preferred embodiment, for which said first biological waste stream has a dry solid content of 35% or less, said third fraction is passed through a heat exchanger following which it may be recycled and mixed e.g. with said hydrolysate or conveyed to the bioreactor. Said third fraction comprises part of the COD contributing compounds of the biological waste material and conveying of at least part of said third fraction to said bioreactor will thus contribute to a more complete utilization of the biological waste material. Recycling of at least part of said third fraction and mixing it with said hydrolysate will dilute said hydrolysate and cause a reduction of the viscosity of said hydrolysate and thereby an easier, i.e. less energy demanding, subsequent decanting process. Furthermore, the dilution of said hydrolysate may cause a washing effect in the sense that more of the soluble part of the COD contributing compounds of the biological waste material in said hydrolysate will be extracted in the decanter.

In any of the above embodiments, said heat exchanger extracts any excess heat from said at least part of said third fraction to achieve a temperature of said at least part of said third fraction in the range of 20° C. to 40° C., so that the microorganisms in the bioreactor are not heat shocked, and at the same time provide means for re-using the heat. The re-usable heat may be used for any purpose. Preferably, the re-usable heat is used to assist in the heating of said first biological waste stream e.g. by assisting in heating water in a boiler generating steam for use in thermal hydrolysis. Reusing the heat reduces the requirement for external supply of energy. If the heat is reused to assist in the thermal hydrolysis, the requirement for external supply of energy is reduced for the thermal hydrolysis step.

Any conventional closed system dryer for drying a waste stream which allows for collection of substantially all evaporating material may be used, such as a paddle dryer configured for collection of substantially all evaporating material.

Regardless of the particular drying process used, the aim is to extract further moisture from the material. For this purpose, energy must be charged to the material. In general, this energy-input can be achieved by:
Convection—by means of a carrier gas
Conduction—hot surfaces
Radiation—microwaves, infrared, solar

In the context of the present invention, drying by convection or conduction by means of superheated steam is preferred.

In the context of the present invention, superheated steam is to be understood as steam that has a temperature above the boiling point at the relevant pressure. Thus, as long as the temperature of the steam remains higher than the saturation temperature (i.e. boiling point) at the relevant pressure, a drop in temperature does not cause condensation. Due to the superior heat transfer properties of superheated steam compared to air (higher thermal conductivity and heat capacity at the same temperature), high drying rates can be achieved with superheated steam.

In the context of the present invention, Superheated Steam Drying by convection is to be understood as a closed-system drying method, which for a given batch of material will involve 3 periods:
1. initial period in which the moisture content of the material may increase because of heat initially being transferred through steam condensation.
2. constant-rate period in which the water from the material moves as a bulk flow from the product, without diffusive resistance at the boundary layer. At an appropriate degree of superheating, the heat transfer coefficient for superheated steam will be higher than for hot dry air. Thus, for the same drying medium temperature, the product reaches a higher temperature in saturated steam (i.e. saturation temperature) than in hot air (i.e. the wet bulb temperature). In other words, above the inversion temperature, superheated steam is a more effective drying agent than humid air or even than dry air.
3. Falling-rate period in which the rate of drying drops because a dry layer forms at the surface of the material. In this period, the temperature of the product increases to that of the superheated steam. The drying rate in this period will also be higher than for hot air drying.

As is evident from the above, applying SSD by convection not only has a positive impact on process time, but also results in a more homogenous drying of the material involved. Also, making use of SSD by convection makes it feasible to reuse the energy of excess steam for other purposes in the methods of the present invention. In such cases, a higher overall energy efficiency can be achieved for the entire process.

In addition, the higher thermal conductivity and heat capacity of superheated steam compared to hot air results in a considerably enhanced heat transfer, not only to the material to be dried, but also to contaminating microorganisms. This effect leads to an inactivation of the microorganisms and to a hygienization of both the material that has been dried and the resulting excess/purged stream or condensate, as the case may be.

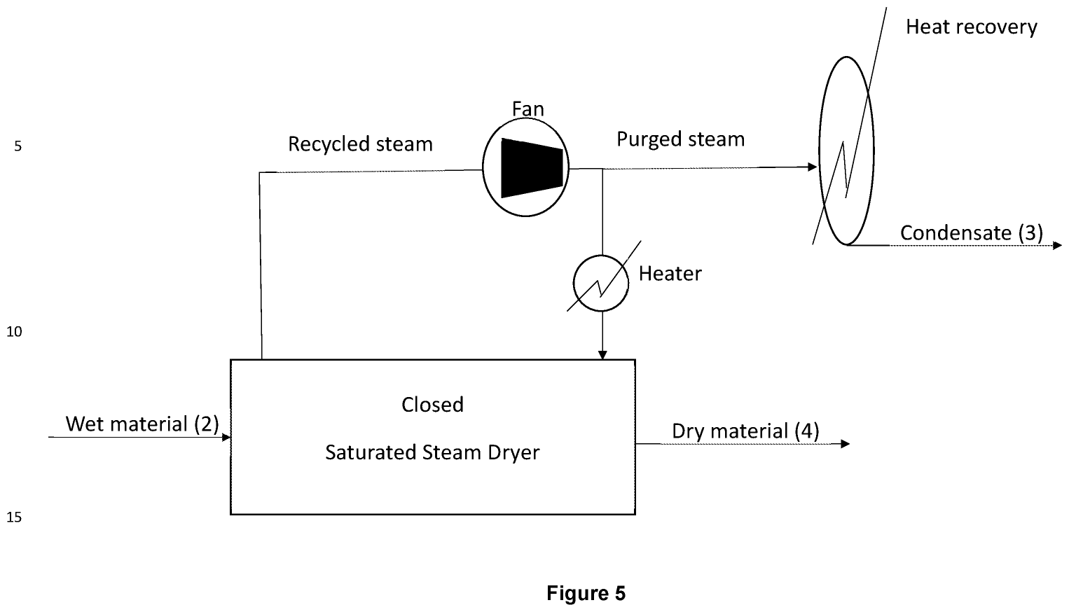

When applying superheated steam for drying by convection, the material to be dried is introduced into the superheated steam atmosphere, where it is heated up convectively (period 1 above), after which its moisture evaporates (period 2 above). Due to the low viscosity of superheated steam, a fast penetration into the biomass material processed in the methods of the present invention is facilitated. Thus, superheated steam drying is especially effective for materials with a porous structure like the biomass material of the present invention and results in a shortened retention time in the drying process. As the evaporation heat is supplied to the material from superheated steam, the steam atmosphere is cooled down. The moisture that is carried off vaporizes and becomes excess steam, which is discharged from the drying chamber in order to regulate the stratification layer. The superheated steam is recirculated and reheated in a closed loop. In this way, the temperature can be kept constant and the steam remains superheated (see FIG. 5).

By exploiting the substantial difference in density between air and steam as well as through proper handling of the material to be dried, any conveying technology can be applied for drying with superheated steam by convection according to the present invention.

In a particularly preferred embodiment of the present invention, superheated steam is used as a heating medium, instead of e.g. air, inside the dryer in line with the above, i.e. heating by convection. Apart from the benefits set out above, the use of superheated steam drying (SSD) instead of air also in a method relying on convection reduces the risk of oxidizing the volatile carbon-based compounds of a biomass material according to the present invention and thereby contributes to increased energy efficiency of the overall process. Oxidization of the volatile carbon-based compounds would, otherwise, lead to a reduced recovery in the bioreactor, i.e. reduced output of e.g. methane from the anaerobic digestion and thereby reduced energy efficiency of the overall process. Furthermore, the use of superheated steam drying reduces the risk of dust explosion inside the dryer reactor and thereby provides a more stable and secure system for drying of waste streams. Thus, in the context of the methods of the present invention, a SSD process provides multiple advantages compared to other drying processes,

In a further preferred embodiment, superheated steam is also used as a heating medium, to apply heat to the outer jacket of the dryer reactor to achieve an efficient heating of the waste stream processed in the dryer by the superheated steam, both by indirect heating by conduction from the inner surface of the jacket and by direct heating by convection from superheated steam flowing through the dryer reactor chamber as a heating medium.

In any of the embodiments, wherein superheated steam is used as a heating medium, said superheated steam may be re-heated by any suitable heating means, such as a natural gas burner or a heat exchanger.

In a most preferred embodiment, a SSD-based dryer for use in a method according to the present invention will comprise a reactor for drying a biological material, a loop system for circulation of steam, circulation means, at least one compressor and a heating means (see FIG. 5).

Preferably, said reactor for drying further comprises stirring means, such as paddles fixed on a rotating axis in the center of said reactor or protrusions on the inner wall of said reactor for drying, for stirring said biological material during the drying process to reduce compaction of the content of said reactor for drying so to achieve a uniform heating of said content of said reactor for drying.

The chamber of said reactor for drying is fluidly connected to a loop system, in which steam may circulate or be circulated. Any suitable circulation means, such as a fan, may be used to ensure a constant and controllable flow of steam through the loop system and said reactor for drying. Said loop system comprises a heating means, such as a natural gas burner or a heat exchanger, for re-heating said superheated process steam, preferably said heating means is a heat exchanger.

Superheated process steam is circulated in the loop system. Superheated steam is steam having a temperature above saturation temperature at a given pressure. Thus, the use of superheated steam to heat up a biological waste material, inside the reaction chamber for drying, will allow for evaporation of water comprised in said material as excess superheated steam, without condensation of the steam fed into the reaction chamber. The flow of superheated process steam in the loop system must be fast enough to ensure that the steam inside the reactor chamber does not reach a temperature at or below the saturation temperature at the pressure inside the reactor for drying, because the steam under such conditions will condensate and re-wet the biological material.

The generation of excess superheated steam will increase the pressure in the loop system. The excess pressure and thereby also the excess superheated steam is relieved/purged through an outlet fluently connecting said loop system and said at least one compressor. Preferably, said outlet fluently connecting said loop system and said at least one compressor, is situated downstream of said circulation means and upstream of re-heating of said superheated process steam (see FIG. 5).

The flow of excess/purged superheated steam through said outlet fluently connecting said loop system and said at least one compressor may be controlled by the intake of excess superheated steam into said at least one compressor creating a pressure gradient causing a flow of excess superheated steam towards said at least one compressor.

Said excess/purged superheated steam is pressurized in at least one compressor to achieve a reheating of said excess superheated steam. Due to inefficiency of said one or more compressors, the heat increase of said excess superheated steam during pressurization will exceed the theoretical heat increase expected based on the pressure increase alone and thereby increase the energy content of said excess superheated steam. Preferably, said excess superheated steam is re-heated to a temperature of at least 110° C., more preferably said excess superheated steam is re-heated to a temperature in the range of 110° C. to 300° C., even more preferably, said excess superheated steam is re-heated to a temperature in the range of 110° C. to 200° C., most preferably said excess superheated steam is re-heated to a temperature in the range of 120° C. to 150° C. Preferably, the excess superheated steam is pressurized to a pressure in the range of 3 bar to 15 bar, more preferably 4 to bar, most preferably 5 bar.

The pressurized excess superheated steam is separated into at least two pressurized excess superheated steam streams, a first pressurized excess superheated steam stream and a second pressurized excess superheated steam stream. Said first pressurized excess superheated steam is conveyed through a heat exchanger, preferably a plate heat exchanger, such as a mechanical vapor recompression (MVR) heat exchanger, which allows for the opening of the heat exchanger and the cleaning of the outside wall of the plates during maintenance, since a certain degree of fouling is expected from the process steam. Said heat exchanger reheats the process steam circulating in the loop system through said reactor for drying. Using pressurized excess superheated steam to reheat the process steam allows for the replacement of a natural gas burner, which is otherwise used in most conventional steam dryers. Said first pressurized excess superheated steam stream will at least partly condensate in said heat exchanger due to the heat exchange and said condensate may be conveyed through an outlet in said heat exchanger (see FIG. 5).

Said second pressurized excess superheated steam stream is conveyed through the outer jacket of said reactor for drying. Said second pressurized excess superheated steam stream exchanges heat with said second fraction inside the reactor for drying, whereby part of said pressurized excess superheated steam will condensate. Preferably, said outer jacket of said reactor for drying further comprises an outlet allowing for collection of excess condensate, which can be further utilized downstream, e.g. by conveying said excess condensate to a bioreactor for anaerobic digestion.

Preferably, said SSD-based dryer is operated at atmospheric pressure within the loop system including the chamber of said reactor for drying and at temperatures inside the reactor chamber of at least 100° C., preferably at temperatures in the range of 105° C. to 200° C., more preferably at temperatures in the range of 110° C. to 150° C.

The loop and SSD-based dryer is placed in a closed system, in the sense that the various steam flows are shielded from contact with the surrounding air. The closed system limits the risk of contamination from the surrounding air.

The condensate conveyed through an outlet in said heat exchanger and the excess condensate collected from the outer jacket of said reactor for drying is collected into said third fraction.

In one embodiment, said excess superheated steam is passed through a steam filter to prevent any particles from entering the at least one compressor. Said steam filter will allow the passage of water soluble and volatile COD contributing compounds present in said excess steam. In the context of this embodiment, it is particularly preferred that said outlet fluently connecting said loop system and said at least one compressor is situated downstream of said circulation means and upstream of re-heating of said superheated process steam. Inefficiency of said circulation means, such as a fan, will increase the temperature of said excess superheated steam, which will reduce the risk of condensation of any excess superheated steam in said steam filter. Furthermore, said circulation means will provide a higher flow of said excess superheated steam through said filter.

The resulting solid fraction from the drying process is collected into said fourth fraction. Said fourth fraction comprises insoluble elements, which are not easily digested in the bioreactor. Said fourth fraction is conveyed to a reactor for pyrolysis and subjected to a pyrolysis process, i.e. heating in an oxygen deficient environment, resulting in the production of Biochar and a fifth fraction comprising the pyrolysis products syngas and/or pyro-oil. The relative proportion of pyrolysis end-products depends on both the input material subjected to pyrolysis and the pyrolysis parameters, i.e. temperature, heating rate and retention time.

In one embodiment, wherein it is preferred to optimize the methane yield, said pyrolysis parameter is adjusted so to yield high levels of the syngas components H2 and CO, which are readily convertible to methane in said bioreactor, and low amounts of pyro-oil which often comprises inhibitory species to the anaerobic digestion, such as ammonia.

In a preferred embodiment, said fourth fraction is pyrolyzed at a target temperature of at least 400° C., preferably said fourth fraction is pyrolyzed at a target temperature in the range of 400° C. to 1000° C., such as 500° C. to 900° C., more preferably said fourth fraction is pyrolyzed at a target temperature in the range of 600° C. to 800° C. Said preferred target temperatures for pyrolysis of said fourth fraction will provide increasingly high levels of the syngas components H2 and CO, which are readily convertible to methane in said bioreactor, and decreasingly low amounts of pyro-oil which often comprises inhibitory species to the anaerobic digestion, such as ammonia.

In a preferred embodiment, said reactor for pyrolysis is heated by means of an electrical heater allowing for precise control of the process parameters especially the heating rate and target temperature.

In a preferred embodiment, a method of the present invention includes the input of a second waste stream into the dryer and/or the reactor for pyrolysis and subjecting said second waste stream to a drying and/or a pyrolysis process.

In the context of the present invention, a second waste stream is to be construed as material comprising carbon-based compounds, wherein said carbon-based compounds are further characterized by mainly comprising elements not readily digestible by microorganisms. Examples of such carbon-based compounds are plastic and lignin.

Optionally, said second or said fourth fraction and said second waste stream are mixed before drying or pyrolysis, the mixing may be achieved prior to entry into said dryer or reactor for pyrolysis or alternatively be achieved by conveying of both streams into the same dryer and/or reactor for pyrolysis. Alternatively, said second or said fourth fraction and said second waste stream may be subjected to drying and/or pyrolysis separately so that the drying and/or pyrolysis parameters may be optimized relative to the input material and preferred output products.

At least part of said fifth fraction is conveyed to said bioreactor for anaerobic digestion, said bioreactor also receiving at least part of said first fraction, where said at least part of said first fraction and said at least part of said fifth fraction are subjected to anaerobic digestion. In most embodiments, conveying at least part of said fifth fraction to said bioreactor will increase the overall yield of methane produced in said bioreactor. Optionally, any remaining part of said syngas and/or pyro-oil comprised in said fifth fraction (5) is used for other purposes such as for fuel which may be used in a boiler for heating water to produce steam (7) for use in the thermal hydrolysis.

In a preferred embodiment, at least part of said Biochar resulting from said pyrolysis is conveyed to said bioreactor. Adding Biochar to the bioreactor provides multiple advantages to the anaerobic digestion process, as well as enhances the quality of the digestate as an end product. Thus, Biochar mitigates ammonia inhibition of the microbiology and thereby contributes to an efficient anaerobic digestion. Furthermore, Biochar will fixate basic nutrients such as phosphorous species, nitrogen species as well as potassium and calcium and thereby reduce nutrient leaching in soils when the digestate is used as fertilizer and thereby increase nutrient availability for plants. Any remaining part of said BioChar may be used for a variety of purposes such as carbon sequestration in soil.

In a preferred embodiment, said third fraction (3) is the condensate resulting from subjecting said second fraction (2) to drying process making use of superheated steam (SSD), and hence will be pathogen free.

The present invention also relates to a system accomplishing the same advantages as described for the method according to the present invention.

The second aspect of the invention relates to a system for processing of biological waste comprising
a) a reactor for thermal hydrolysis
b) a decanter
c) a dryer
d) a reactor for pyrolysis
e) a bioreactor for anaerobic digestion said reactor for thermal hydrolysis being fluently connected to said decanter, and
said decanter being fluently connected to said bioreactor for anaerobic digestion and to said dryer, wherein said decanter is configured to convey a first fraction (1) to said bioreactor for anaerobic digestion having a lower dry solid content relative to the input material received from said reactor for thermal hydrolysis and said decanter being further configured to convey a second fraction (2) to said dryer having a higher dry solid content relative to the input material received from said reactor for thermal hydrolysis and wherein said dry solid content of said second fraction (2) is in the range of 30%-50%, and
said dryer further being fluently connected to said reactor for pyrolysis and wherein said dryer is further fluently connected to said bioreactor and/or fluently connected to said reactor for thermal hydrolysis and wherein said dryer is configured to convey a fourth fraction (4) to said reactor for pyrolysis having a higher dry solid content relative to said second fraction (2) and wherein said dry solid content of said fourth fraction (4) is in the range of 50%-95% and wherein said dryer is further configured to obtain a third fraction (3) having a lower dry solid content relative to said second fraction (2)
said reactor for pyrolysis further being fluently connected to said bioreactor.

In one embodiment of the invention, said system for processing of a biological waste stream comprises
a) a reactor for thermal hydrolysis
b) a decanter
c) a closed system dryer comprising an outer barrier allowing for collection of substantially all evaporating material
d) a reactor for pyrolysis
e) a bioreactor for anaerobic digestion said reactor for thermal hydrolysis being fluently connected to said decanter and,
said decanter being fluently connected to said bioreactor for anaerobic digestion and to said dryer and, said dryer further being fluently connected to said bioreactor and/or having an outlet fluently connected to said reactor for thermal hydrolysis and,
said reactor for pyrolysis further being fluently connected to said bioreactor.

In one embodiment, said reactor for thermal hydrolysis further comprises a gas outlet fluently connected to said bioreactor by a closed system for conveying of gas. In a preferred embodiment, said reactor for thermal hydrolysis further comprises a gas outlet fluently connected to said bioreactor by a closed system for conveying of gas and also, said decanter further comprises a gas outlet fluently connected to said bioreactor by a closed system for conveying of gas.

In both the above embodiments, it is preferred that said closed system for conveying of gas fluently connecting said gas outlet from said reactor for thermal hydrolysis and/or said gas outlet from said decanter to said bioreactor further comprises a heat exchanger allowing for the process gas to be cooled. Cooling said process gas reduces the risk of heating of the content of said bioreactor and thus, contributes to a stable temperature in said bioreactor and thereby an efficient anaerobic digestion. Said process gasses comprise part of the COD contributing compounds of the biological waste material and conveying of said process gasses to said bioreactor will thus contribute to a more complete utilization of the biological waste material. Furthermore, said process gasses may comprise malodorous compounds, such as sulfuric compounds, and conveying of said process gasses to said bioreactor efficiently removes such malodorous compounds as those will be degraded in the bioreactor.

In one embodiment, said dryer is a closed system dryer having an outer barrier for retaining gas species including vapor so that substantially all evaporating material may be collected into said third fraction.

In a preferred embodiment, said dryer having an outer barrier for retaining gas species including vapor is a heat assisted dryer.

In a further preferred embodiment, said dryer is a superheated steam dryer.

In yet a further preferred embodiment, said superheated steam dryer having an outer barrier for retaining gas species including vapor further comprises heating means for re-heating superheated process steam, such as a natural gas burner or a heat exchanger. Preferably, said heating means for re-heating superheated process steam is a heat exchanger.

In a most preferred embodiment, said dryer is an SSD-based dryer comprising a reactor for drying a biological material, a loop system for circulation of superheated steam, steam circulation means, such as a fan, at least one compressor, and a heat exchanger. Preferably, said circulation means is configured to control the flow of superheated steam in said loop system fluently connected to said reactor for drying, and conveying means, such as tubes, are arranged to convey excess superheated steam generated from heating of the content of said reactor for drying to one or more compressors. Preferably, said one or more compressors is/are configured to compress said excess superheated steam to achieve a pressure in the range of 3 bar to 15 bar, more preferably 4 to 10 bar, most preferably 5 bar. Preferably, said conveying means, such as tubes, are arranged to convey a first part of said excess superheated steam to a heat exchanger such as an MVR heat exchanger and a second part of said excess superheated steam to the outer jacket of said reactor for drying and from said outer jacket of said reactor for drying back to said one or more compressors. Preferably, said heat exchanger, such as an MVR heat exchanger is configured for exchanging heat from said excess superheated steam to said superheated process steam in said loop system and said heat exchanger, such as an MVR heat exchanger, is further configured for conveying a condensate through an outlet.

In one embodiment, said SSD-based dryer comprises a particle filter configured for filtering said excess superheated steam prior to entering the one or more compressors. In the context of this embodiment, it is particularly preferred that said outlet fluently connecting said loop system and said at least one compressor, is situated downstream of said circulation means and upstream of re-heating of said superheated process steam.

In a further preferred embodiment said SSD-based dryer further comprises an outlet for a condensate in said outer jacket of said reactor for drying.

In a preferred embodiment, said reactor for pyrolysis is heated by an electrical heater. Said electrical heater is preferably a microwave assisted heater.

In one embodiment, said reactor for pyrolysis comprises a further waste inlet.

In one embodiment, a system according to the present invention further comprises a second reactor for pyrolysis configured for receiving said second waste stream so as to subject said fourth fraction and said second waste stream to pyrolysis in parallel in separate reactors for pyrolysis. Parallel processing of said fourth fraction and said second waste stream allows for adjusting the pyrolysis parameters to the specific type of material fed into said reactors for pyrolysis so as to achieve the output products ratio desired.

In one embodiment, a system according to the present invention further comprises on or more heat exchangers. Preferably, said one or more heat exchangers is/are configured to exchange heat from said first fraction and/or said third fraction to a stream of feed water for a boiler generating steam for use in the thermal hydrolysis.

A system according to the present invention allows for a compact design and may be configured to be installed in a confined space such as on a ship, such as a cruise ship, or in a building complex, such as an apartment complex. Furthermore, a system according to the present invention, when comprising a superheated steam dryer, preferably an SSD-based dryer, provides a safe system having a reduced risk of dust explosion, especially relevant for cruise ships and apartment complexes housing humans. Furthermore, said one or more heat exchangers may be configured to heat various processes on board such ship or in such a building complex, e.g. water for kitchen and/or bath or controlling room temperature.

### DETAILED DESCRIPTION OF THE EXEMPLIFYING FIGURES

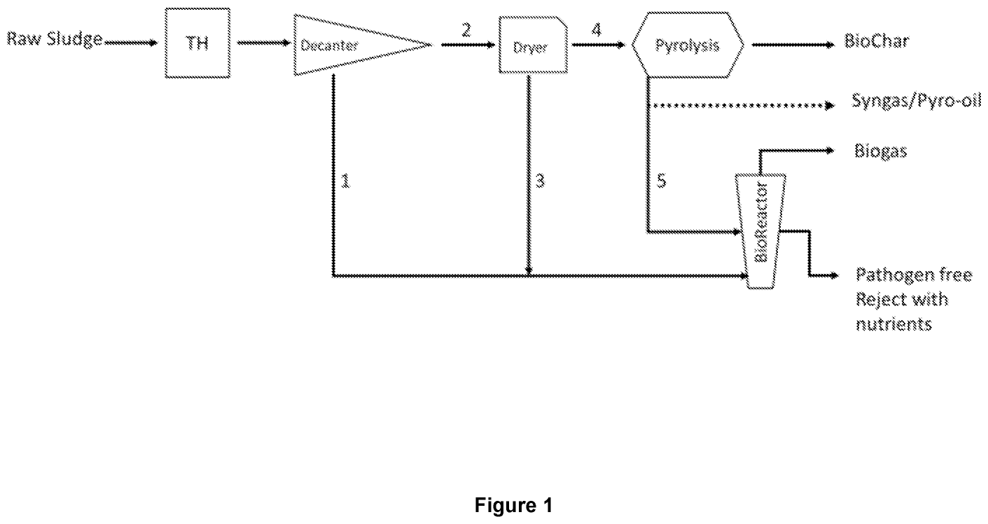

FIG. 1 is a schematic drawing of a waste processing method according to the present invention, wherein a first biological waste stream in the form of raw sludge is conveyed into a reactor for thermal hydrolysis (TH). The dry solid content of said first biological waste stream is adjusted to achieve a dry solid content in the range of 15% to 35%. Said first biological waste stream is subjected to thermal hydrolysis. Following thermal hydrolysis, the resulting hydrolysate is conveyed to a decanter, in which the hydrolysate is separated into two fractions, a sterilized reject as a first fraction (1) having lower dry solid content than the hydrolysate and a second fraction containing the remaining dry solid part (2) having a higher dry solid content than the hydrolysate. Said second fraction (2) is conveyed to an SSD-based dryer, wherein said second fraction (2) is dried by means of superheated steam. Substantially all evaporating material is condensed and collected in a third fraction (3). The remaining fraction from the drying process, having a higher dry solid content relative to said second fraction, is collected into said fourth fraction (4). Said fourth fraction (4) is conveyed to a reactor for pyrolysis and subjected to a pyrolysis process resulting in the production of pyrolysis products including BioChar, Syngas and/or Pyro-oil. The BioChar may be used for a variety of purposes such as carbon sequestration in soil.

Said first fraction (1), said third fraction (3) and at least part of said fifth fraction (5) are all fed to a bioreactor and subjected to anaerobic digestion yielding the biogas, methane, and the digestate form a pathogen free reject with nutrients which may be further used e.g. as a fertilizer. Optionally, part of said syngas and/or pyro-oil comprised in said fifth fraction (5) is used for other purposes such as for fuel.

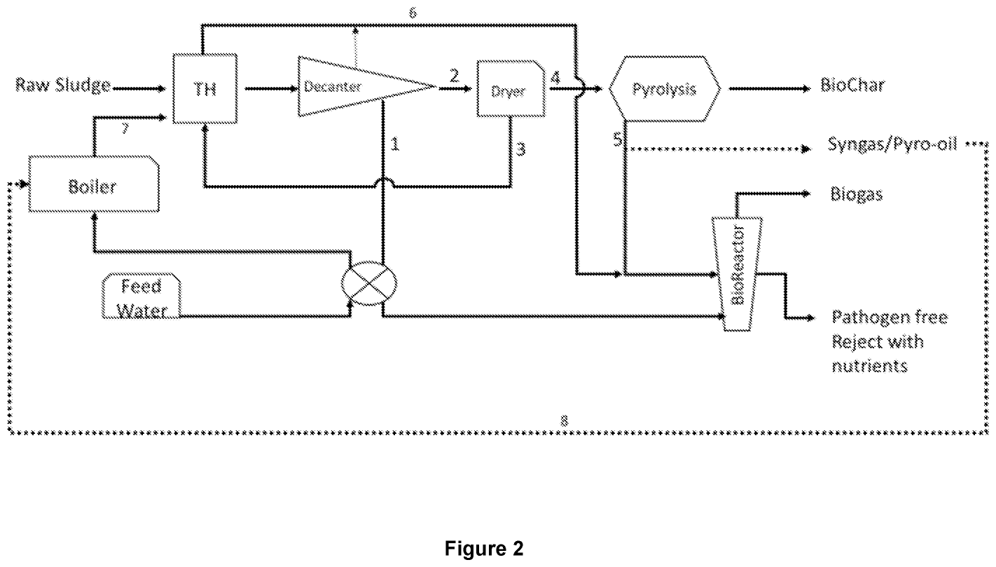

FIG. 2 is a schematic drawing of a waste processing method according to the present invention, wherein a first biological waste stream in the form of raw sludge is conveyed into a reactor for thermal hydrolysis (TH). The dry solid content of said first biological waste stream is adjusted to achieve a dry solid content in the range of 15% to 35%. Said first biological waste stream is subjected to thermal hydrolysis. Process gas formed during thermal hydrolysis is collected in a sixth fraction (6) and conveyed to said bioreactor. Following thermal hydrolysis, the resulting hydrolysate is conveyed to a decanter in which the hydrolysate is separated into two fractions, a sterilized reject as a first fraction (1) having lower dry solid content than the hydrolysate and a second fraction containing the remaining dry solid part (2) having a higher dry solid content than the hydrolysate. Said second fraction (2) is conveyed to a SSD-based dryer wherein said second fraction (2) is dried by means of superheated steam. Substantially all evaporating material is condensed and collected in a third fraction (3). The remaining fraction from the drying process, having a higher dry solid content relative to said second fraction, is collected into said fourth fraction (4). Said fourth fraction (4) is conveyed to a reactor for pyrolysis and subjected to a pyrolysis process resulting in the production of pyrolysis products including BioChar, Syngas and/or Pyro-oil. The BioChar may be used for a variety of purposes such as carbon sequestration in soil.

At least part of said fifth fraction (5) is conveyed to said bioreactor, optionally part of said syngas and/or pyro-oil (8) comprised in said fifth fraction (5) is used as fuel in a boiler for heating water to produce steam (7) for use in the thermal hydrolysis.

Said first fraction (1) is passed through a heat exchanger for cooling said first fraction (1) and further conveyed to a bioreactor. Said heat exchanged is used to assist in the heating of said content in said reactor for thermal hydrolysis (TH).

Said third fraction (3) is conveyed to said reactor for thermal hydrolysis (TH) and thereby pre-heats said content in said reactor for thermal hydrolysis (TH).

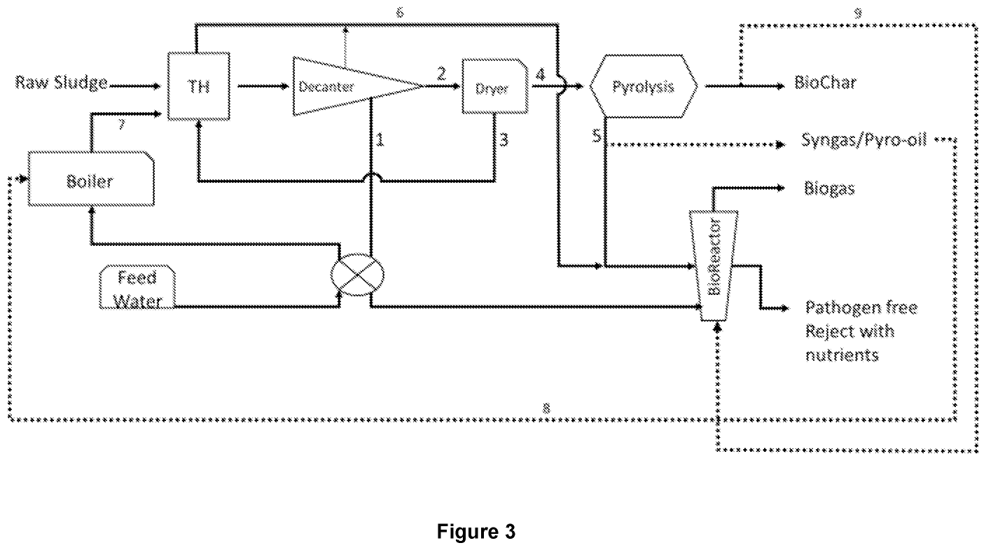

FIG. 3 is a schematic drawing of a waste processing method according to the present invention, wherein a first biological waste stream in the form of raw sludge is conveyed into a reactor for thermal hydrolysis (TH). The dry solid content of said first biological waste stream is adjusted to achieve a dry solid content in the range of 15% to 35%. Said first biological waste stream is subjected to thermal hydrolysis. Process gas formed during thermal hydrolysis is collected in a sixth fraction (6) and conveyed to said bioreactor. Following thermal hydrolysis, the resulting hydrolysate is conveyed to a decanter, in which the hydrolysate is separated into two fractions, a sterilized reject as a first fraction (1) having lower dry solid content than the hydrolysate and a second fraction containing the remaining dry solid part (2) having a higher dry solid content than the hydrolysate. Said second fraction (2) is conveyed to a SSD-based dryer, wherein said second fraction (2) is dried by means of superheated steam. Substantially all evaporating material is condensed and collected in a third fraction (3). The remaining fraction from the drying process, having a higher dry solid content relative to said second fraction, is collected into said fourth fraction (4). Said fourth fraction (4) is conveyed to a reactor for pyrolysis and subjected to a pyrolysis process resulting in the production of pyrolysis products including BioChar, Syngas and/or Pyro-oil. The BioChar may be used for a variety of purposes such as carbon sequestration in soil. Optionally, part of the BioChar is conveyed to the bioreactor to assist in the anaerobic digestion and increase the quality of the sterilized reject with nutrients as a fertilizer.

At least part of said fifth fraction (5) is conveyed to said bioreactor, optionally part of said syngas and/or pyro-oil (8) comprised in said fifth fraction (5) is used as fuel in a boiler for heating water to produce steam (7) for use in the thermal hydrolysis.

Said first fraction (1) is passed through a heat exchanger for cooling said first fraction (1) and further conveyed to a bioreactor. Said heat exchanged is used to assist in the heating of said content in said reactor for thermal hydrolysis (TH).

Said third fraction (3) is conveyed to said reactor for thermal hydrolysis (TH) and thereby pre-heats said content in said reactor for thermal hydrolysis (TH).

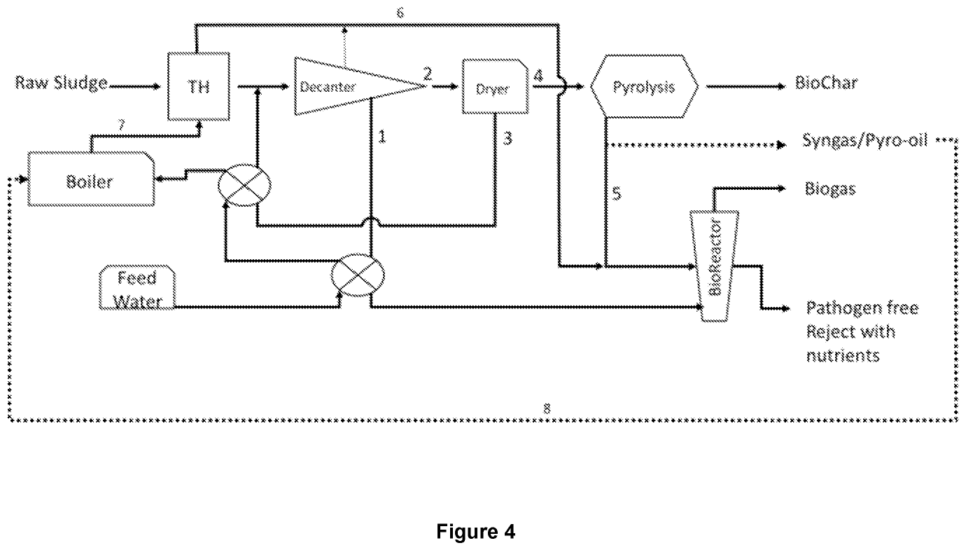

FIG. 4 is a schematic drawing of a waste processing method according to the present invention, wherein a first biological waste stream in the form of raw sludge is conveyed into a reactor for thermal hydrolysis (TH). The dry solid content of said first biological waste stream is adjusted to achieve a dry solid content in the range of 15% to 35%. Said first biological waste stream is subjected to thermal hydrolysis. Process gas formed during thermal hydrolysis is collected in a sixth fraction (6) and conveyed to said bioreactor. Following thermal hydrolysis, the resulting hydrolysate is conveyed to a decanter in which the hydrolysate is separated into two fractions, a sterilized reject as a first fraction (1) having lower dry solid content than the hydrolysate and a second fraction containing the remaining dry solid part (2) having a higher dry solid content than the hydrolysate. Said second fraction (2) is conveyed to a SSD-based dryer, wherein said second fraction (2) is dried by means of superheated steam. Substantially all evaporating material is condensed and collected in a third fraction (3). The remaining fraction from the drying process, having a higher dry solid content relative to said second fraction, is collected into said fourth fraction (4). Said fourth fraction (4) is conveyed to a reactor for pyrolysis and subjected to a pyrolysis process resulting in the production of pyrolysis products including BioChar, Syngas and/or Pyro-oil. The BioChar may be used for a variety of purposes such as carbon sequestration in soil.

At least part of said fifth fraction (5) is conveyed to said bioreactor, optionally part of said syngas and/or pyro-oil (8) comprised in said fifth fraction (5) is used as fuel in a boiler for heating water to produce steam (7) for use in the thermal hydrolysis.

Said first fraction (1) is passed through a heat exchanger for cooling said first fraction (1) and further conveyed to a bioreactor. Said heat exchanged is used to pre-heat water for production of steam (7) for use in thermal hydrolysis.

Said third fraction (3) is also passed through a heat exchanger and further conveyed to and mixed with said hydrolysate. Said heat exchanged is also used to pre-heat water for production of steam (7) for use in thermal hydrolysis.

FIG. 5 is a schematic drawing of a preferred drying method according to the present invention, wherein the remaining dry solid part (2) having a higher dry solid content than the hydrolysate is conveyed to an SSD-based dryer, wherein said second fraction (2) is dried by means of superheated steam. Substantially all evaporating material is condensed and collected in a third fraction (3) in the form of a condensate. The remaining fraction from the drying process, having a higher dry solid content relative to said second fraction (2), is collected into said fourth fraction (4).

### EXAMPLES

### Example 1: Energy Recovery in a Method According to the Present Invention

A biological waste stream having a dry solid content of 19% is subjected to thermal hydrolysis at 150-170° C. in a suitable reactor for that purpose thereby producing a hydrolysate.

The liquid fraction (1) of the hydrolysate is separated from the solid fraction (2) by a decanting centrifuge, resulting in a solid fraction (2) having a dry solid content of 40-50%.

The liquid fraction (1) contains approximately 31% of the COD comprised in the biological waste stream and is conveyed to a bioreactor for anaerobic digestion.

The solid fraction (2) contains approximately 69% of the COD comprised in the biological waste stream and is conveyed to a Superheated Steam Drying-based dryer and subjected to drying resulting in a dry solid content of more than 90%. The SSD dryer has an outer barrier which allow for collection of substantially all evaporating material (3) from the drying step.

The evaporating material (3) from the drying step contains approximately 1-2% of the COD comprised in the biological waste stream and is recycled to the reactor for thermal hydrolysis. In particular, using an SSD results in a condensate of the evaporated material (3) of typically 4 bar and 140° C. Furthermore, the COD contained in the condensate from the evaporating material (3) from the drying step is maintained within the overall process and adds to the COD content of the liquid fraction (1) from the decanter centrifuge.

The solid fraction (4) from the drying step contains approximately 68% of the COD comprised in the biological waste stream and is conveyed to a reactor for pyrolysis and subjected to pyrolysis 550-600° C. producing BioChar, syngas and pyro-oil.

The BioChar contains approximately 15% of the COD comprised in the biological waste stream and can be collected, whereas the remaining part of the pyrolysis product contains approximately 53% of the COD (4% in the aqueous pyrolysis liquid and 49% in syngas) and is conveyed to the bioreactor.

Anaerobic digestion of the collected fractions in the bioreactor produces biogas containing approximately 59% of the COD comprised in the biological waste stream, while approximately 26% of the COD comprised in the biological waste stream remains in the digestate and approximately 15% of the COD comprised in the biological waste stream is contained in the BioChar available for further energy production.

The COD content of a given sample can be measured by the sealed tube method as described in the standards ISO 15705:2002 (DIN ISO 15705—H45), EPA 410.4, APHA 5220D, or DIN 38409—H41-1, or by element analysis (CHNSO) as described in the standard ISO 16634-1:2008 when appropriate.

Typically, traditional anaerobic digestion could recover 50% of the COD in the form of methane. This process provides a high degree of recovery of the energy stored in the waste material measured by the COD content. In particularly, keeping the COD content of the evaporating material (3) within the overall process contributes to a more complete utilization of the energy contained in the biological waste material. Furthermore, reuse of heat within the overall process reduces the demand for external energy and thereby the overall costs associated with the process.

1. A method for processing of waste comprising the steps of;
a) subjecting a first biological waste stream having a dry solid content in the range of 15-35% to thermal hydrolysis producing a hydrolysate
b) subjecting said hydrolysate to decanting, whereby said hydrolysate is separated into at least a first fraction (1) and a second fraction (2), wherein said first fraction (1) is characterized by having a lower dry solid content relative to said hydrolysate and wherein said second fraction (2) is characterized by having a higher dry solid content relative to said hydrolysate and wherein the dry solid content of said second fraction (2) is in the range of 30%-50%
c) subjecting said second fraction (2) to drying in a closed system dryer, whereby said second fraction (2) is separated into at least a third fraction (3) comprising substantially all evaporating material and having a lower dry solid content than said second fraction (2) and a fourth fraction (4) having a higher dry solid content relative to said second fraction (2), and wherein said dry solid content of said fourth fraction (4) is in the range of 50-95%
d) subjecting said fourth fraction (4) to pyrolysis resulting in the production of BioChar and a fifth fraction (5) comprising syngas and/or pyro-oil
e) subjecting said first fraction (1) and at least part of said fifth fraction (5) to anaerobic digestion in a bioreactor
f) subjecting said third fraction (3) to anaerobic digestion in said bioreactor or recycle said third fraction (3) to said biological waste stream and/or said hydrolysate or subjecting part of said third fraction (3) to anaerobic digestion in said bioreactor and recycle the remaining part of said third fraction (3) to said biological waste stream and/or said hydrolysate.

2. A method according to claim 1, wherein at least part of said BioChar is conveyed to said bioreactor.

3. A method according to claim 1, wherein said dryer is a superheated steam dryer (SSD).

4. A method according to claim 1, wherein said third fraction (3) is used as a heating medium in at least one heat exchanger.

5. A method according to claim 1, wherein at least part of said first fraction (1) and/or at least part of said third fraction (3) is passed through one or more heat exchangers for cooling said first fraction (1) and/or at least part of said third fraction (3), and wherein said heat exchanged is used to assist in the heating of said content in said reactor for thermal hydrolysis.

6. A method according to claim 1, wherein process gasses escaping said thermal hydrolysis and/or said decanting step are/is subjected to anaerobic digestion in said bioreactor.

7. A method according to claim 1, wherein a second waste stream is fed into said second fraction (2) or said fourth fraction (4).

8. A method according to claim 1, wherein said syngas and/or pyro-oil produced during said pyrolysis are/is used to assist in the heating of said content of said reactor for thermal hydrolysis and/or said second fraction (2), preferably by using said syngas and/or pyro-oil as fuel for a boiler producing steam for said thermal hydrolysis of said content.

9. A system for processing of a biological waste stream comprising
a) a reactor for thermal hydrolysis
b) a decanter
c) a closed system dryer comprising an outer barrier allowing for collection of substantially all evaporating material
d) a reactor for pyrolysis
e) a bioreactor for anaerobic digestion
said reactor for thermal hydrolysis being fluently connected to said decanter and,
said decanter being fluently connected to said bioreactor for anaerobic digestion and to said dryer and, said dryer further being fluently connected to said bioreactor and/or having an outlet fluently connected to said reactor for thermal hydrolysis and,
said reactor for pyrolysis further being fluently connected to said bioreactor.

10. A system according to claim 9, wherein said reactor for thermal hydrolysis further comprises a gas outlet connected to said bioreactor by a closed system for conveying of gas.

11. A system according to claim 9, wherein said decanter further comprises a gas outlet connected to said bioreactor by a closed system for conveying of gas.

12. A system according to claim 9 wherein said dryer is a superheated steam dryer (SSD).

13. A system according to claim 9, wherein said reactor for pyrolysis is heated by an electrical heater.

14. A system according to claim 9, further comprising one or more heat exchangers.

15. A system according to claim 9, wherein said reactor for pyrolysis comprises a further waste inlet.

16. A system according to claim 9, wherein said dryer comprises a further waste inlet.
